(19) United States
(12) Patent Application Publication
(10) Pub. No.: US 2018/0143654 A1
(43) Pub. Date: May 24, 2018

(54) WARM-UP COMPENSATION SYSTEM AND METHOD

(71) Applicant: INSTITUTE FOR INFORMATION INDUSTRY, Taipei (TW)

(72) Inventors: Chow-Shih WANG, Changhua County (TW); Hung-Sheng CHIU, Taipei City (TW); Yu-Chi LIU, Taichung City (TW); Hsiao-Chen CHANG, Taipei City (TW); Yao-Chang TSAI, Changhua County (TW)

(21) Appl. No.: 15/369,903

(22) Filed: Dec. 6, 2016

(30) Foreign Application Priority Data
Nov. 18, 2016 (TW) 105137927

(51) Int. Cl. G05D 23/19; G05B 19/406

(52) U.S. Cl. CPC G05D 23/1917; G05B 2219/43103; G05B 19/406

(57) ABSTRACT

The present disclosure provides warm-up compensation system and method. This method includes steps as follow. Critical area of a machine is analyzed, where the critical area includes a plurality of critical temperature-sensitive blocks and at least one critical heating block. Then, temperature sensors are used to detect the temperature of the critical areas of the machine. The correspondence relationship among temperature changes of critical areas, tilt angle changes of a spindle of the machine and temperature changes of the at least one critical heating block along heating time. The critical area of the machine is compensated in accordance with the correspondence relationship. Whether the temperature of the spindle has reached equilibrium is determined.

### RELATED APPLICATIONS

This application claims priority to Taiwanese Application Serial Number 105137927, filed Nov. 18, 2016, which is herein incorporated by reference.

### BACKGROUND

### Field of Invention

The present invention relates to compensation systems and methods. More particularly, the present invention relates to warm-up compensation systems and methods.

### Description of Related Art

Before the machine is powered on for processing the work piece, it must be perform warm-up procedures to ensure that the machine operates in a normal operating temperature. When the machine is booted at morning or its maintenance is finished, the manufacturers do not adjust the warm-up time according to the ambient temperature, machine temperature and other conditions. Moreover, after the machine is shutdown in short time because of machine maintenance, replacement of the work piece, modifying the processing program, temporary downtime repair and so on, the machine is rebooted again and the manufacturers do not adjust the warm-up time. The warm-up time is currently decided by the experience of the operator, but the utilization rate is reduced, and the operator cannot decide the completion of warm-up.

In addition, in the current warm-up process for the machine, the obvious asymmetry of the heat source and structure of the machine results in complex temperature displacement of a cutting point. The position of the spindle of the machine is changed from the offset (linear thermal deformation) to a tilting (non-linear thermal deformation). When the spindle works in the tilting phenomenon to perform a cutting process, the processing accuracy is decreased.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

According to embodiments of the present disclosure, the present disclosure provides a warm-up compensation system and method, to solve or circumvent aforesaid problems and disadvantages.

In one embodiment, the warm-up compensation system comprises: a heating element disposed on the machine, wherein the machine comprises a spindle; a displacement meter configured to obtain a tilt angle of the spindle; a plurality of temperature sensors disposed on the machine respectively; and a processor device electrically connected to the heating element, the displacement meter and the temperature sensors, wherein the processor device divides the machine into a plurality of temperature-sensitive candidate blocks, wherein each of the temperature sensors are disposed on one of the temperature-sensitive candidate blocks respectively; when the machine operates at a constant speed, the temperature sensors periodically capture temperatures of the temperature-sensitive candidate blocks, the processor device determines that a plurality of critical temperature sensed blocks of the temperature-sensitive candidate blocks mainly affect the inclination of the spindle according to the temperatures of the temperature-sensitive candidate blocks and the tilt angle of the spindle, and records a critical temperature sense information, the critical temperature sense information comprises a relationship between a temperature change of the critical temperature sensed blocks and a change of the tilt angle of the spindle, and the processor device sets non-critical temperature-sensitive blocks of the temperature-sensitive candidate blocks as a plurality of heating candidate blocks, wherein when the machine operates at a constant speed, the heating element heats the heating candidate blocks individually, the processor device finds at least one critical heating block that most affects the inclination of the spindle from the heating candidate blocks and records a critical heating information, and the critical heating information comprises a relationship between the temperature change of the at least one critical heating block along heating time and the change of the tilt angle of the spindle, wherein the critical temperature sense information and the critical heating information serve as a basis of a accelerating warm-up compensation for the machine.

In one embodiment, when the machine operates at the constant speed, the processor device further captures the tilt angle of the spindle every a predetermined time interval through the displacement meter and simultaneously capture the temperatures of the temperature-sensitive candidate blocks through the temperature sensors until the tilt angle of the spindle is not changed, so as to record a capturing period; the processor device analyzes a correlation between the temperature change of each of the temperature-sensitive candidate blocks and the change of the tilt angle of the spindle, to find the critical temperature sensed blocks; the processor device calculates the relationship between the temperature change of the critical temperature sensed blocks along the capturing period and the change of the tilt angle of the spindle according to the temperature captured every the predetermined time interval and the tilt angle, so as to records the critical temperature sense information.

In one embodiment, the machine further comprises a column body, the column body and the spindle are disposed perpendicularly to each other, and the spindle is configured to perform a reciprocating movement along the column body.

In one embodiment, the processor device divides the heating candidate blocks into a plurality of heating candidate blocks of the spindle and a plurality of heating candidate blocks of the column body; the heating element heats the heating candidate blocks of the spindle individually, so that the processor device finds at least one first critical heating block that mainly affect the inclination of the spindle from the heating candidate blocks of the spindle; the heating element heats the heating candidate blocks of the column body individually, so that the processor device finds at least one second critical heating block that mainly affect the inclination of the spindle from the heating candidate blocks of the column body, wherein the at least one critical heating block of the machine comprises the at least one first and second critical heating blocks, the heating element simultaneously increases temperature of the at least one first and second critical heating blocks of the spindle and the column body, and the processor device analyzes a relationship between temperature change of the at least one first and second critical heating blocks along heating time and the change of the tilt angle of the spindle.

In one embodiment, a warm-up compensation system, comprises: a heating element disposed on a machine, wherein the machine comprises a spindle; a displacement meter configured to obtain a tilt angle of the spindle; a plurality of temperature sensors disposed on the machine; and a processor device electrically connected to the heating element and the temperature sensors, wherein the processor device previously analyzes the critical blocks of the machine, the critical blocks comprises a plurality of critical temperature sensed blocks and at least one critical heating block, so that the temperature sensors detect temperatures of the critical blocks of the machine, and the processor device establishes a relationship among a temperature change of the critical temperature sensed blocks, a change of the tilt angle of the spindle, and a temperature change of the at least one critical heating block along heating time, compensates the temperatures of the critical blocks of the machine according to the relationship, and determines whether a temperature of the spindle has reached equilibrium.

In one embodiment, the machine further comprises a controller to control the machine to perform a preset warm-up procedure, and during the preset warm-up procedure, the processor device captures the temperature of the critical temperature sensed blocks and the temperature of the at least one critical heating block of the machine through the temperature sensors.

In one embodiment, the processor device further analyzes an expected temperature of the critical temperature sensed blocks of the machine and an estimated heating temperature of the at least one critical heating block of the machine according to the relationship.

In one embodiment, the processor device performs temperature compensation on the at least one critical heating block through the heating element according to the estimated heating temperature.

In one embodiment, the processor device determines whether the temperature of the critical temperature sensed blocks reaches the expected temperature; when the temperature of the critical temperature sensed blocks reaches the expected temperature, the processor device performs a notification to indicate a warm-up completion.

In one embodiment, a warm-up compensation method comprises steps of: (A) dividing the machine into a plurality of temperature-sensitive candidate blocks; (B) when the machine operates at the constant speed, using temperature sensors to periodically capture temperatures of the temperature-sensitive candidate blocks, determining that a plurality of critical temperature sensed blocks of the temperature-sensitive candidate blocks mainly affect an inclination of the spindle according to the temperatures of the temperature-sensitive candidate blocks and a tilt angle of the spindle, and recording a critical temperature sense information, wherein the critical temperature sense information comprises a relationship between a temperature change of the critical temperature sensed blocks and a change of the tilt angle of the spindle; (C) setting non-critical temperature-sensitive blocks of the temperature-sensitive candidate blocks as a plurality of heating candidate blocks; and (D) when the machine operates at the constant speed, using the heating element to heat the heating candidate blocks individually, finding at least one critical heating block that most affects the inclination of the spindle from the heating candidate blocks and recording a critical heating information, wherein the critical heating information comprises a relationship between the temperature change of the at least one critical heating block along heating time and the change of the tilt angle of the spindle, wherein the critical temperature sense information and the critical heating information serve as a basis of a accelerating warm-up compensation for the machine.

In one embodiment, the step (B) comprises: when the machine operates at the constant speed, capturing the tilt angle of the spindle every a predetermined time interval through the displacement meter and simultaneously capturing the temperatures of the temperature-sensitive candidate blocks through the temperature sensors until the tilt angle of the spindle is not changed, so as to record a capturing period; analyzing a correlation between the temperature change of each of the temperature-sensitive candidate blocks and the change of the tilt angle of the spindle, to find the critical temperature sensed blocks; calculating the relationship between the temperature change of the critical temperature sensed blocks along the capturing period and the change of the tilt angle of the spindle according to the temperature captured every the predetermined time interval and the tilt angle, so as to records the critical temperature sense information.

In one embodiment, the machine further comprises a column body, the column body and the spindle are disposed perpendicularly to each other, and the spindle is configured to perform a reciprocating movement along the column body.

In one embodiment, the step (D) comprises: dividing the heating candidate blocks into a plurality of heating candidate blocks of the spindle and a plurality of heating candidate blocks of the column body; using the heating element to heat the heating candidate blocks of the spindle individually, to find at least one first critical heating block that mainly affect the inclination of the spindle from the heating candidate blocks of the spindle; using the heating element to heat the heating candidate blocks of the column body individually, to find at least one second critical heating block that mainly affect the inclination of the spindle from the heating candidate blocks of the column body, wherein the at least one critical heating block of the machine comprises the at least one first and second critical heating blocks, using the heating element to simultaneously increase temperature of the at least one first and second critical heating blocks of the spindle and the column body, and analyzing a relationship between temperature change of the at least one first and second critical heating blocks along heating time and the change of the tilt angle of the spindle.

In one embodiment, a warm-up compensation method, comprising steps of: (A) previously analyzing critical blocks of a machine, the critical blocks comprises a plurality of critical temperature sensed blocks and at least one critical heating block, and using a plurality of temperature sensors to detect temperatures of the critical blocks of the machine; (B) establishing a relationship among a temperature change of the critical temperature sensed blocks, a change of a tilt angle of the spindle, and a temperature change of the at least one critical heating block along heating time; (C) compensating the temperatures of the critical blocks of the machine according to the relationship; and (D) determining whether a temperature of the spindle has reached equilibrium.

In one embodiment, the machine further comprises a controller, the step (A) comprises: using the controller to control the machine for performing a preset warm-up procedure; and using the temperature sensors to capture the temperature of the critical temperature sensed blocks and of the temperature the at least one critical heating block of the machine.

In one embodiment, the step (B) comprises: analyzing an expected temperature of the critical temperature sensed blocks of the machine according to the relationship; and analyzing an estimated heating temperature of the at least one critical heating block of the machine according to the relationship.

In one embodiment, the step (C) comprises: performing temperature compensation on the at least one critical heating block through the heating element according to the estimated heating temperature.

In one embodiment, the step (D) comprises: determining whether the temperature of the critical temperature sensed blocks reaches the expected temperature; and when the temperature of the critical temperature sensed blocks reaches the expected temperature, performing a notification to indicate a warm-up completion.

In view of the foregoing, the present disclosure can be used with a warmer program of a controller manufacturer when the machine is cold-started, and the warm-up compensation system and method of the present disclosure can adjust the warm-up time intelligently responsive to the ambient temperature and the temperature of the machine, thereby shortening the warm-up time preset by the manufacturers so as to improve the utilization rate. The warm-up compensation system and method focus on critical blocks (e.g., the backside of the column body and the topside of the spindle) for calculation and temperature compensation to improve the machining accuracy. When the machine is rebooted at a second time, the present disclosure provides real-time temperature compensation for the machine in respect of the ambient temperature and the temperature of the machine, so as to maintain the machining accuracy. Moreover, the present disclosure can be applied to various types of machines, such as a lathe, a milling machine and a machining center.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a block diagram of a warm-up compensation system according to one embodiment of the present disclosure; and

FIG. 2 is a side view of a machine according to one embodiment of the present disclosure;

FIG. 3 is a flow chart of a warm-up compensation method according to one embodiment of the present disclosure; and

FIG. 4 is a flow chart of a warm-up compensation method according to another embodiment of the present disclosure.

### DETAILED DESCRIPTION

In the following detailed description, for purposes of explanation, numerous specific details are set forth in order to attain a thorough understanding of the disclosed embodiments. In accordance with common practice, like reference numerals and designations in the various drawings are used to indicate like elements/parts. Moreover, well-known elements or method steps are schematically shown or omitted in order to simplify the drawing and to avoid unnecessary limitation to the claimed invention.

In the detailed embodiment and the claims, unless otherwise indicated, the article “a” or “the” refers to one or more than one of the word modified by the article “a” or “the.”

Through the present specification and the annexed claims, the description involving the “electrical connection” refers to the cases where one component is electrically connected to another component indirectly via other component(s), or one component is electrically connected to another component directly without any other component.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

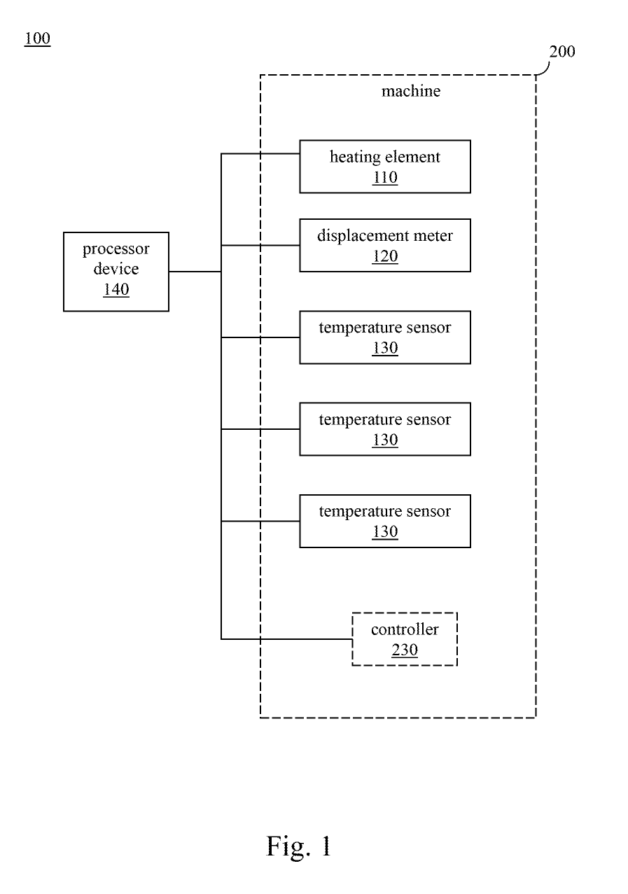

FIG. 1 is a block diagram of a warm-up compensation system 100 according to one embodiment of the present disclosure. As illustrated in FIG. 1, the warm-up compensation system 100 is electrically connected to the machine 200. In practice, the warm-up compensation system 100 can be an embedded device, a set-top box or a similar circuit device. The machine 200 can be a lathe, a milling machine, a machining center or the like.

The warm-up compensation system 100 comprises a heating element 110, a displacement meter 120, temperature sensors 130 and a processor device 140. Structurally, the processor device 140 is electrically connected to the heating element 110, the displacement meter 120 and the temperature sensors 130. In practice, the heating element 110 may be a resistive heater, the displacement meter 120 may be a displacement sensor or other displacement measurement element, the temperature sensors 130 may be a temperature sensing line or other temperature sensing element, and the processor device 140 may be a central processing unit (CPU), a micro controller, or the like.

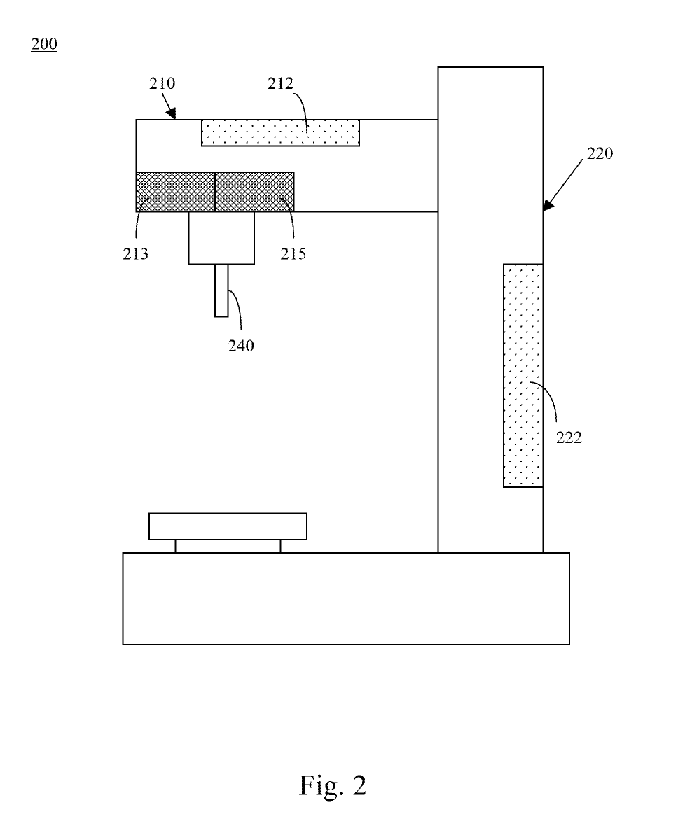

The temperature sensors 130 are disposed on the machine 200 respectively. In one embodiment, the number of the temperature sensors 130 is three, or six for complete deployment, and one sensing area needs one temperature sensor 130. The heating element 110 is disposed on the machine 200, the machine 200 comprises a spindle 210 (shown in FIG. 2). The displacement meter 120 obtains a tilt angle of the spindle 210. Specifically, the displacement meter 120 detects the tilt angle of a cutting tool 240 (shown in FIG. 2), and thus obtains the tilt angle of the spindle 210 according to the tilt angle of the cutting tool 240.

In use, the processor device 140 divides the machine 200 into a plurality of temperature-sensitive candidate blocks, the size or the amount of temperature-sensitive candidate blocks can be adjusted depending on the type of the machine 200, wherein the temperature sensors 130 are disposed on a temperature-sensitive candidate blocks respectively. When the machine 200 operates at the constant speed (for example: the spindle 210 has no load and operates at 70% of maximum speed), the temperature sensors 130 periodically capture temperatures of the temperature-sensitive candidate blocks. The processor device 140 determines that a plurality of critical temperature sensed blocks 213 and 215 (shown in FIG. 2) of the temperature-sensitive candidate blocks mainly affect an inclination of the spindle 210 according to the temperatures of the temperature-sensitive candidate blocks and the tilt angle of the spindle 210, and records critical temperature sense information. The critical temperature sense information comprises a relationship between a temperature change of the critical temperature sensed blocks and a change of the tilt angle of the spindle 210. The processor device 140 sets non-critical temperature-sensitive blocks of the temperature-sensitive candidate blocks as a plurality of heating candidate blocks. When the machine 200 operates at the constant speed, the heating element 110 heats the heating candidate blocks individually, the processor device 140 finds at least one critical heating block that most affects the inclination of the spindle from the heating candidate blocks and records critical heating information, and the critical heating information comprises a relationship between the temperature change of the at least one critical heating block along heating time and the change of the tilt angle of the spindle 210. The critical temperature sense information and the critical heating information serve as a basis of a accelerating warm-up compensation for the machine 200.

When the machine 200 operates at the constant speed, the processor device 140 further captures the tilt angle of the spindle 210 every a predetermined time interval through the displacement meter 120 and simultaneously capture the temperatures of the temperature-sensitive candidate blocks through the temperature sensors 130 until the tilt angle of the spindle 210 is not changed, so as to record a capturing period. The processor device 140 analyzes a correlation between the temperature change of each of the temperature-sensitive candidate blocks and the change of the tilt angle of the spindle, to find the critical temperature sensed blocks. The processor device 140 calculates the relationship between the temperature change of the critical temperature sensed blocks along the capturing period and the change of the tilt angle of the spindle 210 according to the temperature captured every the predetermined time interval and the tilt angle, so as to records the critical temperature sense information.

FIG. 2 is a side view of the machine 200 according to one embodiment of the present disclosure. As illustrated in FIG. 2, the machine 200 further comprises a column body 220, the column body 220 and the spindle 210 are disposed perpendicularly to each other, and the spindle 210 is configured to perform a reciprocating movement along the column body 220. In one embodiment, the cutting tool 240 is disposed at the spindle 210, but the present disclosure is not limited thereto.

Referring to FIGS. 1 and 2, the processor device 140 divides the heating candidate blocks into a plurality of heating candidate blocks of the spindle 210 and a plurality of heating candidate blocks of the column body 220. The heating element 110 heats the heating candidate blocks of the spindle 210 individually, so that the processor device 140 finds at least one first critical heating block 212 that mainly affect the inclination of the spindle 210 from the heating candidate blocks of the spindle 210. The heating element 110 heats the heating candidate blocks of the column body 220 individually, so that the processor device 140 finds at least one second critical heating block 222 that mainly affect the inclination of the spindle 210 from the heating candidate blocks of the column body 220. The above-mentioned at least one critical heating block of the machine 200 comprises the at least one first and second critical heating blocks 212 and 222, the heating element 110 simultaneously increases temperature of the at least one first and second critical heating blocks 212 and 222 of the spindle 210 and the column body 220, and the processor device 140 analyzes a relationship between temperature change of the at least one first and second critical heating blocks 212 and 222 along heating time and the change of the tilt angle of the spindle 210.

Accordingly, in the accelerated warm-up and the spindle correction algorithm of the present disclosure, the processor device 140 previously analyzes the critical blocks of the machine 200, the critical blocks comprises a plurality of critical temperature sensed blocks and at least one critical heating block, so that the temperature sensors 130 detect temperatures of the critical blocks of the machine 200, and then the processor device 140 establishes a relationship among a temperature change of the critical temperature sensed blocks, a change of the tilt angle of the spindle, and a temperature change of the at least one critical heating block along heating time.

Then, the processor device 140 compensates the temperatures of the critical blocks of the machine 200 according to above relationship, and determines whether a temperature of the spindle 210 has reached equilibrium.

The machine 200 further comprises a controller 230. The controller 230 controls the machine 200 to perform a preset warm-up procedure, and during the preset warm-up procedure, the processor device 140 captures the temperature of the critical temperature sensed blocks and the temperature of the at least one critical heating block of the machine through the temperature sensors 130.

The processor device 140 further analyzes an expected temperature of the critical temperature sensed blocks of the machine 200 and an estimated heating temperature of the at least one critical heating block of the machine 200 according to above relationship.

The processor device 140 performs temperature compensation on the at least one critical heating block through the heating element 110 according to the estimated heating temperature.

The processor device 140 determines whether the temperature of the critical temperature sensed blocks reaches the expected temperature. When the temperature of the critical temperature sensed blocks reaches the expected temperature, the processor device 140 performs a notification (for example: an output component sends out message, or a speaker emits sound) to indicate a warm-up completion.

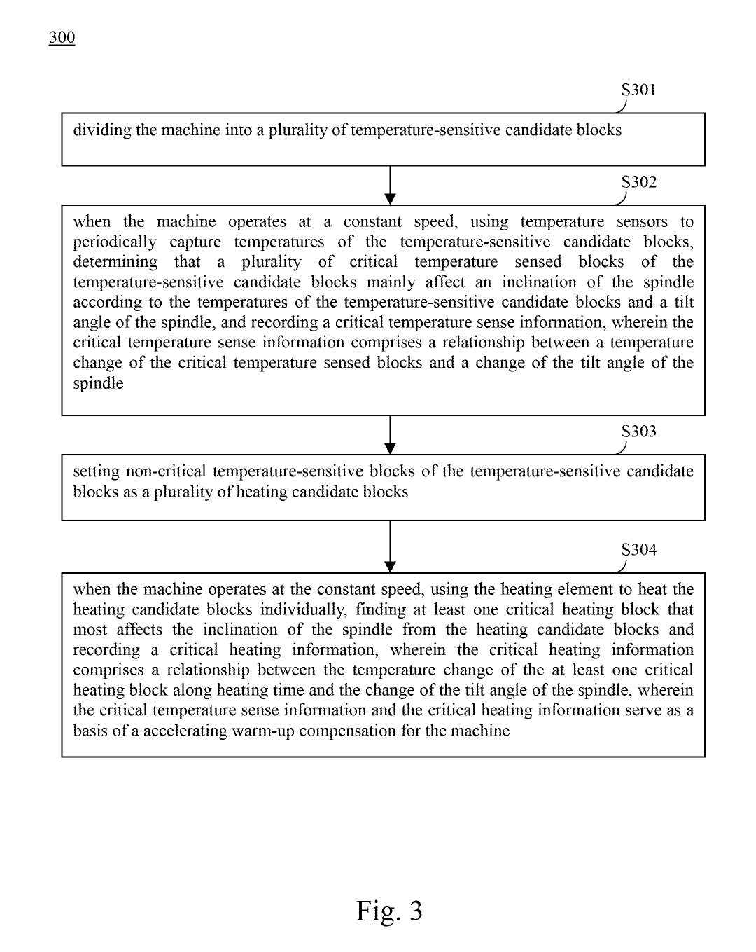

For a more complete understanding of a warm-up compensation method performed by the warm-up compensation system 100, refer to FIG. 3. FIG. 3 is a flow chart of the warm-up compensation method 300 according to one embodiment of the present disclosure. As illustrated in FIG. 3, the warm-up compensation method 300 includes the operations S301-S304. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently. With reference to FIGS. 1-3, some embodiments are explanted below.

In operation S301, the machine 200 is divided into a plurality of temperature-sensitive candidate blocks. In operation S302, when the machine 200 operates at the constant speed, using temperature sensors to periodically capture temperatures of the temperature-sensitive candidate blocks, it is determined that a plurality of critical temperature sensed blocks 213 and 215 of the temperature-sensitive candidate blocks mainly affect an inclination of the spindle 210 according to the temperatures of the temperature-sensitive candidate blocks and the tilt angle of the spindle, and recording a critical temperature sense information, wherein the critical temperature sense information comprises a relationship between a temperature change of the critical temperature sensed blocks and a change of the tilt angle of the spindle. In operation S303, non-critical temperature-sensitive blocks of the temperature-sensitive candidate blocks are set as a plurality of heating candidate blocks. In operation S304, when the machine 200 operates at the constant speed, the heating element 110 is used to heat the heating candidate blocks individually, finding at least one critical heating block 212 and/or 222 that most affects the inclination of the spindle from the heating candidate blocks and recording a critical heating information, wherein the critical heating information comprises a relationship between the temperature change of the at least one critical heating block along heating time and the change of the tilt angle of the spindle. The critical temperature sense information and the critical heating information serve as a basis of a accelerating warm-up compensation for the machine 200.

In operation S302, when the machine 200 operates at the constant speed, the tilt angle of the spindle 210 is captured every a predetermined time interval through the displacement meter 120 and simultaneously the temperatures of the temperature-sensitive candidate blocks are captured through the temperature sensors 130 until the tilt angle of the spindle 210 is not changed, so as to record a capturing period. A correlation between the temperature change of each of the temperature-sensitive candidate blocks and the change of the tilt angle of the spindle, to find the critical temperature sensed blocks is analyzed. the relationship between the temperature change of the critical temperature sensed blocks along the capturing period and the change of the tilt angle of the spindle 210 is calculated according to the temperature captured every the predetermined time interval and the tilt angle, so as to records the critical temperature sense information.

In operation S304, the heating candidate blocks are divided into a plurality of heating candidate blocks of the spindle 210 and a plurality of heating candidate blocks of the column body 220. The heating element 110 is used to heat the heating candidate blocks of the spindle 210 individually, so as to find at least one first critical heating block 212 that mainly affect the inclination of the spindle 210 from the heating candidate blocks of the spindle 210. The heating element 110 is used to heat the heating candidate blocks of the column body 220 individually, so as to find at least one second critical heating block 222 that mainly affect the inclination of the spindle 210 from the heating candidate blocks of the column body 220. The above-mentioned at least one critical heating block of the machine 200 comprises the at least one first and second critical heating blocks 212 and 222, the heating element 110 simultaneously increases temperature of the at least one first and second critical heating blocks 212 and 222 of the spindle 210 and the column body 220, and thus, a relationship between temperature change of the at least one first and second critical heating blocks 212 and 222 along heating time and the change of the tilt angle of the spindle 210 analyzed.

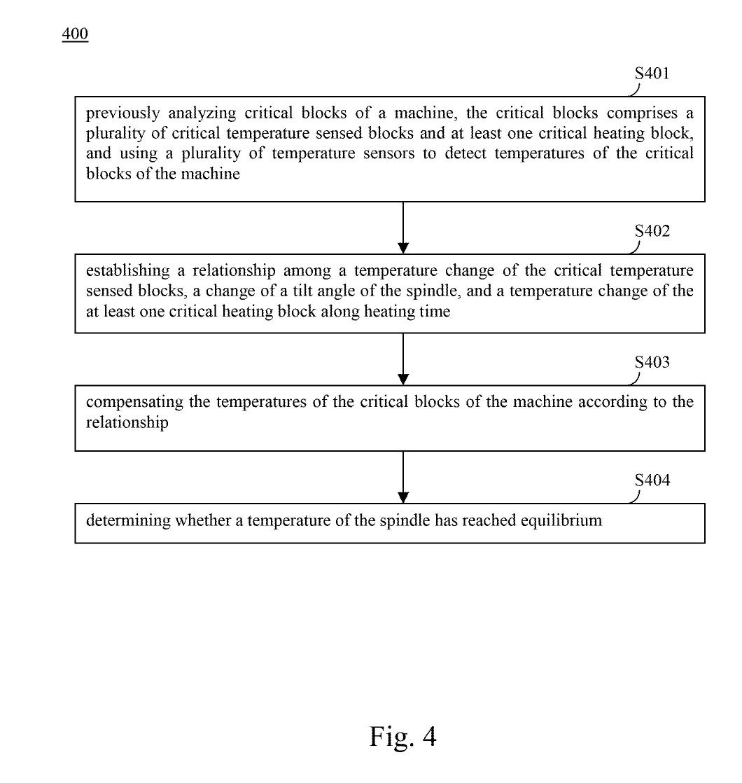

For a more complete understanding of a follow-up warm-up compensation method performed by the warm-up compensation system 100, refer to FIG. 4. FIG. 4 is a flow chart of the warm-up compensation method 400 according to another embodiment of the present disclosure. As illustrated in FIG. 4, the warm-up compensation method 400 includes the operations S401-S404. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently. With reference to FIGS. 1, 2 and 4, some embodiments are explanted below.

In operation S401, the critical blocks of the machine 200 are analyzed previously, the critical blocks comprises a plurality of critical temperature sensed blocks and at least one critical heating block, so that the temperature sensors 130 detect temperatures of the critical blocks of the machine 200. In operation S402, a relationship among a temperature change of the critical temperature sensed blocks, a change of the tilt angle of the spindle, and a temperature change of the at least one critical heating block along heating time is established. In operation S403, the temperatures of the critical blocks of the machine 200 are compensated according to aforesaid relationship. In operation S404, it is determined whether a temperature of the spindle 210 has reached equilibrium.

In operation S401, the controller 230 is used to control the machine 200 to perform a preset warm-up procedure. During the preset warm-up procedure, the temperature of the critical temperature sensed blocks and the temperature of the at least one critical heating block of the machine 200 are captured through the temperature sensors 130.

In operation S402, an expected temperature of the critical temperature sensed blocks of the machine 200 is analyzed according to above relationship, and an estimated heating temperature of the at least one critical heating block of the machine 200 according to above relationship is analyzed.

In operation S403, temperature compensation is performed on the at least one critical heating block through the heating element 110 according to the estimated heating temperature.

In operation S404, it is determined whether the temperature of the critical temperature sensed blocks reaches the expected temperature. When the temperature of the critical temperature sensed blocks reaches the expected temperature, the processor device 140 performs a notification to indicate a warm-up completion.

In view of the foregoing, the present disclosure can be used with a warmer program of a controller 230 of the manufacturer when the machine 200 is cold-started, and the warm-up compensation system 100 and method of the present disclosure can adjust the warm-up time intelligently responsive to the ambient temperature and the temperature of the machine, thereby shortening the warm-up time preset by the manufacturers so as to improve the utilization rate. The warm-up compensation system 100 and method focus on critical blocks of the machine 200 (e.g., the backside of the column body and the topside of the spindle) for calculation and temperature compensation to improve the machining accuracy. When the machine 200 is rebooted at a second time, the present disclosure provides real-time temperature compensation for the machine in respect of the ambient temperature and the temperature of the machine 200, so as to maintain the machining accuracy. Moreover, the present disclosure can be applied to various types of machine 200, such as a lathe, a milling machine and a machining center.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. A warm-up compensation system, comprising:
a heating element disposed on the machine, wherein the machine comprises a spindle;
a displacement meter configured to obtain a tilt angle of the spindle;
a plurality of temperature sensors disposed on the machine respectively; and
a processor device electrically connected to the heating element, the displacement meter and the temperature sensors, wherein the processor device divides the machine into a plurality of temperature-sensitive candidate blocks, wherein each of the temperature sensors are disposed on one of the temperature-sensitive candidate blocks respectively; when the machine operates at a constant speed, the temperature sensors periodically capture temperatures of the temperature-sensitive candidate blocks, the processor device determines that a plurality of critical temperature sensed blocks of the temperature-sensitive candidate blocks mainly affect the tilt angle of the spindle according to the temperatures of the temperature-sensitive candidate blocks and the tilt angle of the spindle, and records a critical temperature sense information, wherein the critical temperature sense information comprises a relationship between a temperature change of the critical temperature sensed blocks and a change of the tilt angle of the spindle; and the processor device sets non-critical temperature-sensitive blocks of the temperature-sensitive candidate blocks as a plurality of heating candidate blocks, wherein when the machine operates at the constant speed, the heating element heats the heating candidate blocks individually, the processor device finds at least one critical heating block that most affects the inclination of the spindle from the heating candidate blocks and records a critical heating information, and the critical heating information comprises a relationship between the temperature change of the at least one critical heating block along heating time and the change of the tilt angle of the spindle, wherein the critical temperature sense information and the critical heating information serve as a basis of a accelerating warm-up compensation for the machine.

2. The warm-up compensation system of claim 1, wherein when the machine operates at the constant speed, the processor device further captures the tilt angle of the spindle every a predetermined time interval through the displacement meter and simultaneously capture the temperatures of the temperature-sensitive candidate blocks through the temperature sensors until the tilt angle of the spindle is not changed, so as to record a capturing period; the processor device analyzes a correlation between the temperature change of each of the temperature-sensitive candidate blocks and the change of the tilt angle of the spindle, to find the critical temperature sensed blocks; the processor device calculates the relationship between the temperature change of the critical temperature sensed blocks along the capturing period and the change of the tilt angle of the spindle according to the temperature captured every the predetermined time interval and the tilt angle, so as to records the critical temperature sense information.

3. The warm-up compensation system of claim 1, wherein the machine further comprises a column body, the column body and the spindle are disposed perpendicularly to each other, and the spindle is configured to perform a reciprocating movement along the column body.

4. The warm-up compensation system of claim 3, wherein the processor device divides the heating candidate blocks into a plurality of heating candidate blocks of the spindle and a plurality of heating candidate blocks of the column body; the heating element heats the heating candidate blocks of the spindle individually, so that the processor device finds at least one first critical heating block that mainly affect the inclination of the spindle from the heating candidate blocks of the spindle; the heating element heats the heating candidate blocks of the column body individually, so that the processor device finds at least one second critical heating block that mainly affect the inclination of the spindle from the heating candidate blocks of the column body, wherein the at least one critical heating block of the machine comprises the at least one first and second critical heating blocks, the heating element simultaneously increases temperature of the at least one first and second critical heating blocks of the spindle and the column body, and the processor device analyzes a relationship between temperature change of the at least one first and second critical heating blocks along heating time and the change of the tilt angle of the spindle.

5. A warm-up compensation system, comprising:
a heating element disposed on a machine, wherein the machine comprises a spindle;
a displacement meter configured to obtain a tilt angle of the spindle;
a plurality of temperature sensors disposed on the machine; and
a processor device electrically connected to the heating element and the temperature sensors, wherein the processor device previously analyzes the critical blocks of the machine, the critical blocks comprises a plurality of critical temperature sensed blocks and at least one critical heating block, so that the temperature sensors detect temperatures of the critical blocks of the machine, and the processor device establishes a relationship among a temperature change of the critical temperature sensed blocks, a change of the tilt angle of the spindle, and a temperature change of the at least one critical heating block along heating time, compensates the temperatures of the critical blocks of the machine according to the relationship, and determines whether a temperature of the spindle has reached equilibrium.

6. The warm-up compensation system of claim 5, wherein the machine further comprises a controller to control the machine to perform a preset warm-up procedure, and during the preset warm-up procedure, the processor device captures the temperature of the critical temperature sensed blocks and the temperature of the at least one critical heating block of the machine through the temperature sensors.

7. The warm-up compensation system of claim 6, wherein the processor device further analyzes an expected temperature of the critical temperature sensed blocks of the machine and an estimated heating temperature of the at least one critical heating block of the machine according to the relationship.

8. The warm-up compensation system of claim 7, wherein the processor device performs temperature compensation on the at least one critical heating block through the heating element according to the estimated heating temperature.

9. The warm-up compensation system of claim 8, wherein the processor device determines whether the temperature of the critical temperature sensed blocks reaches the expected temperature; when the temperature of the critical temperature sensed blocks reaches the expected temperature, the processor device performs a notification to indicate a warm-up completion.

10. A warm-up compensation method, comprising steps of:
(A) dividing the machine into a plurality of temperature-sensitive candidate blocks;
(B) when the machine operates at a constant speed, using temperature sensors to periodically capture temperatures of the temperature-sensitive candidate blocks, determining that a plurality of critical temperature sensed blocks of the temperature-sensitive candidate blocks mainly affect an inclination of the spindle according to the temperatures of the temperature-sensitive candidate blocks and a tilt angle of the spindle, and recording a critical temperature sense information, wherein the critical temperature sense information comprises a relationship between a temperature change of the critical temperature sensed blocks and a change of the tilt angle of the spindle;
(C) setting non-critical temperature-sensitive blocks of the temperature-sensitive candidate blocks as a plurality of heating candidate blocks; and
(D) when the machine operates at the constant speed, using the heating element to heat the heating candidate blocks individually, finding at least one critical heating block that most affects the inclination of the spindle from the heating candidate blocks and recording a critical heating information, wherein the critical heating information comprises a relationship between the temperature change of the at least one critical heating block along heating time and the change of the tilt angle of the spindle, wherein the critical temperature sense information and the critical heating information serve as a basis of a accelerating warm-up compensation for the machine.

11. The warm-up compensation method of claim 10, wherein the step (B) comprises:
when the machine operates at the constant speed, capturing the tilt angle of the spindle every a predetermined time interval through the displacement meter and simultaneously capturing the temperatures of the temperature-sensitive candidate blocks through the temperature sensors until the tilt angle of the spindle is not changed, so as to record a capturing period;
analyzing a correlation between the temperature change of each of the temperature-sensitive candidate blocks and the change of the tilt angle of the spindle, to find the critical temperature sensed blocks;
calculating the relationship between the temperature change of the critical temperature sensed blocks along the capturing period and the change of the tilt angle of the spindle according to the temperature captured every the predetermined time interval and the tilt angle, so as to records the critical temperature sense information.

12. The warm-up compensation method of claim 10, wherein the machine further comprises a column body, the column body and the spindle are disposed perpendicularly to each other, and the spindle is configured to perform a reciprocating movement along the column body.

13. The warm-up compensation method of claim 12, wherein the step (D) comprises:
dividing the heating candidate blocks into a plurality of heating candidate blocks of the spindle and a plurality of heating candidate blocks of the column body;
using the heating element to heat the heating candidate blocks of the spindle individually, to find at least one first critical heating block that mainly affect the inclination of the spindle from the heating candidate blocks of the spindle;
using the heating element to heat the heating candidate blocks of the column body individually, to find at least one second critical heating block that mainly affect the inclination of the spindle from the heating candidate blocks of the column body, wherein the at least one critical heating block of the machine comprises the at least one first and second critical heating blocks,
using the heating element to simultaneously increase temperature of the at least one first and second critical heating blocks of the spindle and the column body, and analyzing a relationship between temperature change of the at least one first and second critical heating blocks along heating time and the change of the tilt angle of the spindle.

14. A warm-up compensation method, comprising steps of:
(A) previously analyzing critical blocks of a machine, the critical blocks comprises a plurality of critical temperature sensed blocks and at least one critical heating block, and using a plurality of temperature sensors to detect temperatures of the critical blocks of the machine;
(B) establishing a relationship among a temperature change of the critical temperature sensed blocks, a change of a tilt angle of the spindle, and a temperature change of the at least one critical heating block along heating time;
(C) compensating the temperatures of the critical blocks of the machine according to the relationship; and
(D) determining whether a temperature of the spindle has reached equilibrium.

15. The warm-up compensation method of claim 14, wherein the machine further comprises a controller, the step (A) comprises:
using the controller to control the machine for performing a preset warm-up procedure; and
using the temperature sensors to capture the temperature of the critical temperature sensed blocks and of the temperature the at least one critical heating block of the machine.

16. The warm-up compensation method of claim 15, wherein the step (B) comprises:
analyzing an expected temperature of the critical temperature sensed blocks of the machine according to the relationship; and
analyzing an estimated heating temperature of the at least one critical heating block of the machine according to the relationship.

17. The warm-up compensation method of claim 16, wherein the step (C) comprises:
performing temperature compensation on the at least one critical heating block through the heating element according to the estimated heating temperature.

18. The warm-up compensation method of claim 17, wherein the step (D) comprises:
determining whether the temperature of the critical temperature sensed blocks reaches the expected temperature; and
when the temperature of the critical temperature sensed blocks reaches the expected temperature, performing a notification to indicate a warm-up completion.
